(19) United States
(12) Patent Application Publication
(10) Pub. No.: US 2025/0319692 A1
(43) Pub. Date: Oct. 16, 2025

(54) AUTOMOBILE INTERIOR MATERIAL AND MANUFACTURING METHOD THEREOF

(71) Applicants: Hyundai Motor Company, Seoul (KR); Kia Corporation, Seoul (KR); Korea Vilene Co., Ltd., Pyeongtaek-si (KR)

(72) Inventors: Hong Chan Jeon, Seoul (KR); Seong Je Kim, Namyangju (KR); Yong Kgil Jung, Pyeongtaek (KR); Se Young Jung, Pyeongtaek (KR); Jong Oh Kang, Suwon (KR)

(21) Appl. No.: 18/943,696

(22) Filed: Nov. 11, 2024

(30) Foreign Application Priority Data
Apr. 11, 2024 (KR) 10-2024-0048805

(51) Int. Cl. B32B 27/12; B05D 5/06; B32B 7/12; B32B 27/36; B60R 13/02

(52) U.S. Cl. CPC B32B 27/12; B05D 5/061; B32B 7/12; B32B 27/36; B60R 13/02; B32B 2262/0284; B32B 2601/00; B32B 2605/003

(57) ABSTRACT

Provided is an automobile interior material comprising a non-woven fabric base layer, an acrylic resin coating layer, a print layer with a predetermined pattern, a transparent film layer made of thermoplastic polyurethane resin (TPU), and a transparent adhesive layer. Both the film and adhesive layers have a total light transmittance of 90% or more and a haze value between 70% and 80%. The material may include perforations for air bubble removal and enhanced sound absorption, with the film layer featuring protruding and depressed parts. The manufacturing method involves forming these layers, printing the pattern, applying the adhesive, adhering the film, and perforating to remove air bubbles.

### CROSS-REFERENCE TO RELATED APPLICATION

This application claims the benefit of Korean Patent Application No. 10-2024-0048805, filed in the Korean Intellectual Property Office on Apr. 11, 2024, the entire contents of which are incorporated herein by reference.

### BACKGROUND

### Technical Field

The present disclosure relates to automobile interior materials, specifically to a multi-layered interior material that combines a non-woven fabric base layer, a coating layer, a patterned print layer, a transparent film layer, and a transparent adhesive layer. This material is designed for aesthetic and functional applications within vehicle interiors, providing enhanced visual appeal, durability, and acoustic performance. More particularly, the automobile interior material, made of a non-woven fabric, serves as an outer material covering the interior parts of an automobile, maintaining a pattern undamaged even on curved surfaces, and improving the efficiency of expressing color and texture.

### Background

The interior of an automobile is made up of various types of interior materials. An automobile interior material is a material that finishes or decorates the interior of an automobile. Specifically, the automobile interior material refers to a material used for a dashboard, a ceiling, a seat, a floor mat, etc.

In particular, an interior material made of plastic is widely used in places such as a dashboard, a ceiling, and a door. Plastic has a series of shapes, and an outer surface thereof is molded to have a texture such as wood grain or chrome.

The texture of the outer surface of an interior material may be achieved through painting or coating, or may be realized by wrapping the outer surface with an outer layer having a series of textures.

Korean Patent Application Publication No. 10-2017-0018580 (hereinafter, referred to as “related technology 1”) discloses “ARTIFICIAL LEATHER USING POLYESTER AND MANUFACTURING METHOD THEREOF”.

The related technology 1 includes a base substrate layer made of polyester fabric, an adhesive layer laminated on one surface of the base substrate layer, and a skin film layer laminated on one surface of the adhesive layer.

Artificial leather fabric made through related technology 1 is used to wrap the interior of an automobile with various curves. In this case, in a portion with a large curve, a shape printed on the artificial leather fabric may look rough. Additionally, a pattern formed on the artificial leather fabric may be deformed depending on the curvature of a material wrapped by the artificial leather fabric.

Accordingly, a technology to solve these problems has been required.

### SUMMARY

The present disclosure has been made to solve the above-mentioned problems occurring in the prior art while advantages achieved by the prior art are maintained intact.

An aspect of the present disclosure provides an automobile interior material that prevents a pattern printed on fabric from being deformed in a curved surface or bent section.

Another aspect of the present disclosure provides an automobile interior material that prevents the texture of fabric from appearing rough partially.

Another aspect of the present disclosure is to give depth to a pattern on fabric and protect the pattern from external contamination.

The technical problems to be solved by the present disclosure are not limited to the aforementioned problems, and any other technical problems not mentioned herein will be clearly understood from the following description by those skilled in the art to which the present disclosure pertains.

In some embodiments, an automobile interior material includes a base layer comprising a non-woven fabric, a coating layer disposed on the base layer and comprising one or more emulsions selected from the group consisting of nylon, acryl, styrene, polyvinylchloride, polyvinyl alcohol, polyester, ethylene vinylchloride, ethylene vinyl acetate, and polyurethane, a print layer disposed on the coating layer and comprising a predetermined pattern printed thereon, a film layer disposed on the print layer, wherein the film layer comprises thermoplastic polyurethane resin (TPU), and an adhesive layer provided between the print layer and the film layer, wherein each of the film layer and the adhesive layer has transparency, having a total light transmittance Tt of 90% or more and a haze value of 70% or more and 80% or less.

The automobile interior material may further comprise a perforation penetrating the film layer and the adhesive layer, wherein the perforation includes about 1,000 perforations or more and about 10,000 perforations or less per 1 m² on a basis of the film layer. The perforation may have a diameter of 850 μm or less. The film layer may include a plurality of protruding parts protruding from a surface of the film layer, and a depressed part arranged between the plurality of protruding parts. The perforation may be formed on each of the plurality of protruding parts.

Each of the adhesive layer and the film layer may have a haze value of about 70% or more and about 80% or less measured by a haze meter. The print layer may be printed by rotary screen printing. The coating layer may further comprise an additive selected from the group consisting of a penetrant, a thickener, and an antifoaming agent. The non-woven fabric of the base layer may be formed by carding or cross-webbing thin fibers to form a web of about 3 to about 10 layers, and coupling the layers to each other by needle punching or pressing.

In some embodiments, a vehicle may comprise the automobile interior material.

As discussed, the method and system suitably include use of a controller or processer.

In another embodiment, vehicles are provided that comprise an apparatus as disclosed herein.

### BRIEF DESCRIPTION OF THE DRAWINGS

The above and other objects, features and advantages of the present disclosure will be more apparent from the following detailed description taken in conjunction with the accompanying drawings:

FIG. 1 is a partial cross-sectional view of an automobile interior material according to an embodiment of the present disclosure;

FIG. 2 is an image showing a cross section of the automobile interior material according to an embodiment of the present disclosure;

FIG. 3 is an enlarged view of a surface of the automobile interior material according to an embodiment of the present disclosure;

FIG. 4 is a flowchart showing the manufacturing method of the automobile interior material according to an embodiment of the present disclosure;

FIG. 5 is a state diagram showing a process of forming a base layer by using a needle punching machine in the manufacturing method of the automobile interior material according to an embodiment of the present disclosure;

FIG. 6 is a state diagram showing the process of perforating a film layer and forming a pattern in the manufacturing method of the automobile interior material according to an embodiment of the present disclosure;

FIGS. 7A, 7B, 8A, and 8B are photos of surfaces of automobile interior materials; and

FIG. 9 is an image showing a curved state of the automobile interior material according to an embodiment of the present disclosure.

### DETAILED DESCRIPTION OF EMBODIMENTS

The advantages and features of the present disclosure and methods for achieving them will become clear by referring to embodiments described in detail below along with the accompanying drawings. However, the present disclosure is not limited to the embodiments disclosed below and will be implemented in various different forms. These embodiments are provided solely to ensure that the disclosure of the present disclosure is complete and to fully inform those skilled in the art of the present disclosure of the scope of the present disclosure, and the present disclosure is only defined by the scope of the claims.

When an element or layer is referred to as being “on” another element or layer, it includes all cases where the element or layer is placed directly on the top of another element or still another layer or element is interposed therebetween. Likewise, things referred to as being on “bottom,” “left,” and “right” include a case where they are directly adjacent to other elements or a case where another layer or another material is interposed therebetween. Like reference numerals refer to like elements throughout the specification.

Each feature of the various embodiments of the present disclosure can be coupled or connected with each other, partially or entirely, and various technological interconnections and operations are possible, and each embodiment may be implemented independently of each other or together in a related relationship.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, specific embodiments will be described with reference to the attached drawings.

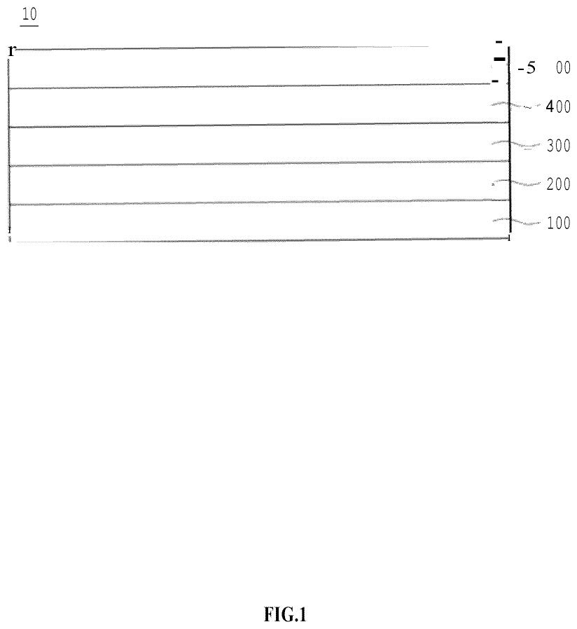

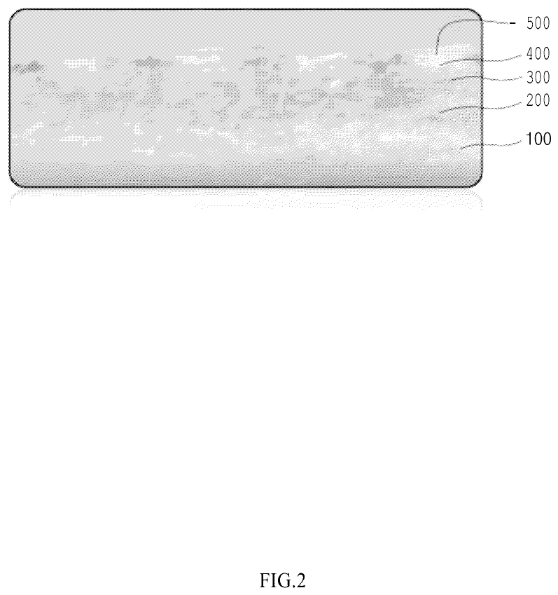

FIG. 1 is a partial cross-sectional view of an automobile interior material 10 according to an embodiment of the present disclosure, and FIG. 2 is an image showing a cross section of the automobile interior material 10 according to an embodiment of the present disclosure.

Referring to FIGS. 1 and 2, the automobile interior material 10 according to an embodiment of the present disclosure consists of multiple layers.

The automobile interior material 10 according to an embodiment of the present disclosure is made of a flexible material that is bendable. In addition, the automobile interior material 10 may be used to cover parts inside an automobile.

The automobile interior material 10 according to an embodiment of the present disclosure includes a base layer 100, a coating layer 200, a print layer 300, an adhesive layer 400, and a film layer 500.

According to an embodiment of the present disclosure, the base layer 100, which is a part serving as the basis of the automobile interior material 10, is formed as a non-woven fabric made by forming a web of laminated 3 to 10 layers by carding or cross-webbing thin fibers and coupling the layers to each other by needle punching or pressing.

In the present disclosure, carding refers to a process of arranging fibers parallel to each other by stretching each of a mass of tangled raw fibers in a straight line, and cross webbing refers to a process of forming a predetermined surface by weaving the strands of fibers that have undergone the carding.

According to an embodiment of the present disclosure, the base layer 100 may be made of a member commonly referred to as a non-woven fabric or felt, and may be implemented as fibers of various materials having predetermined widths depending on embodiments to which the present disclosure is applied. Thus, when the base layer 100 is made of a non-woven fabric or felt, a pattern printed on the automobile interior material 10 may not be damaged when the automobile interior material 10 wraps each of automobile interior parts with curved surfaces.

According to an embodiment of the present disclosure, the coating layer 200 is formed on one surface of the base layer 100, in other words, on the upper surface of the base layer 100 in FIGS. 1 and 2.

According to one embodiment of the present disclosure, the coating layer 200 may be made by mixing one type or at least two types of emulsions such as nylon, acryl, styrene, polyvinylchloride, polyvinyl alcohol, polyester, ethylenevinylchloride, ethylene vinyl acetate, polyurethane, etc.

According to an embodiment of the present disclosure, the coating layer 200 may include an additive such as a penetrant. The penetrant may be a surfactant and, for a specific example, may be a silicone-based surfactant. The penetrant may serve to induce coating liquid forming the coating layer 200 to penetrate deeply into the base layer 100.

According to an embodiment of the present disclosure, the print layer 300 is formed on one surface of the coating layer 200, that is, on the upper surface of the coating layer 200 in the drawing. The print layer 300 forms a print pattern that gives aesthetics to the automobile interior material 10, and may have a predetermined pattern formed thereon.

According to an embodiment of the present disclosure, the print layer 300 may form a series of patterns on the coating layer 200.

Specifically, to create a series of patterns or characters, or to form a mesh-like pattern by using paint or ink, additives such as thickeners and antifoaming agents may be mixed with a base emulsion such as nylon, acryl, styrene, polyvinylchloride, polyvinyl alcohol, polyester, ethylenevinylchloride, ethylene vinyl acetate, polyurethane, etc., so that the series of patterns or characters, or the mesh-like pattern may be printed on one surface of the coating layer 200.

According to an embodiment of the present disclosure, when the print layer 300 is printed on one surface of the coating layer 200 by mixing additives such as thickeners and antifoaming agents with the base emulsion to form a mesh-like pattern, the print layer 300 may be printed by rotary screen printing. Rotary screen printing has the advantage that a process is able to continue without interruption, production speed is fast, and time to replace a printed design or pattern is short.

According to an embodiment of the present disclosure, the film layer 500 is formed on one surface of the print layer 300, in other words, on the upper surface of the print layer 300 in FIGS. 1 and 2. The film layer 500 may give a sense of depth to a printed pattern formed by the print layer 300 and may serve to protect the print layer 300 from being contaminated or deformed from the outside.

According to an embodiment of the present disclosure, the film layer 500 may be attached to one surface of the print layer 300 by the adhesive layer 400 provided between the print layer 300 and the film layer 500.

According to an embodiment of the present disclosure the adhesive layer 400 may be made of the same material as the material of the coating layer 200 described above, or may be made of a separate adhesive material.

According to an embodiment of the present disclosure, resins used in the film layer 500 may include thermoplastic polyurethane resin (TPU), thermoplastic elastomer (TPE), polyethylene (PE), polyamide (PA), polypropylene (PP), polyethylene terephthalate (PET), polycarbonate (PC), thermoplastic polyester elastomer (TPEE), etc.

In addition, according to an embodiment of the present disclosure, the film layer 500 and the adhesive layer 400 may have transparency. Meanwhile, in the present specification, having transparency may mean that total light transmittance Tt measured by using a haze meter is 90% or more and a haze value is 70% or more and 80% or less. Accordingly, a pattern printed on the print layer 300 disposed below the film layer 500 and the adhesive layer 400 may be clearly exposed and have a sense of depth provided thereto.

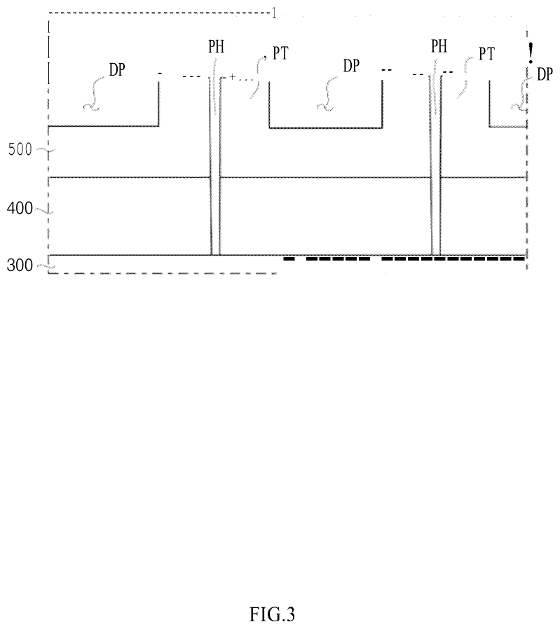

FIG. 3 is an enlarged view of a surface of the automobile interior material 10 according to an embodiment of the present disclosure.

Referring to FIG. 3, a plurality of protruding parts (dh) PT protruding from one surface of the film layer 500 and a depressed part (L) DP formed between the plurality of protruding parts PT may be formed on the one surface of the film layer 500 according to an embodiment of the present disclosure. Specifically, each of the protruding parts PT may include a protrusion surface protruding from one surface of the film layer 500 in a thickness direction thereof, and the depressed part DP may be formed between the plurality of protruding parts PT and have a thickness smaller than each of the protruding parts PT. The depressed part DP and the protruding parts PT may function to give a three-dimensional effect and tactile effect corresponding to the printed pattern of the automobile interior material 10.

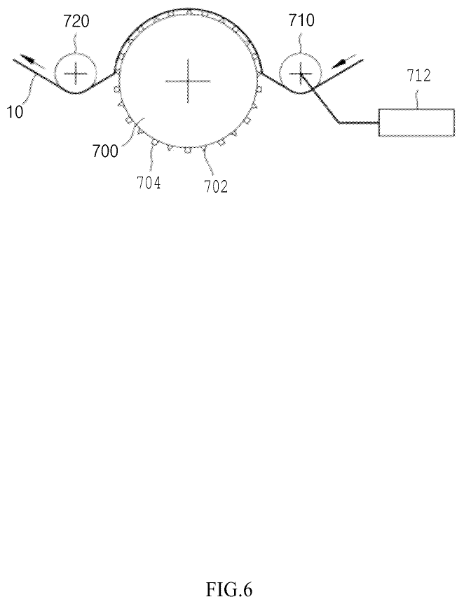

According to an embodiment of the present disclosure, the depressed part DP and the protruding parts PT may be formed by perforating protrusions 702 and patterning protrusions 704 formed on the outer circumference of a forming roller 700 in a manufacturing process to be described later (see FIG. 6).

According to an embodiment of the present disclosure, perforations PH passing through the film layer 500 may be formed in the film layer 500. Each of the perforations PH may function to efficiently discharge gas that may be generated in the manufacturing process of the automobile interior material 10 to be described later, and improving sound absorption.

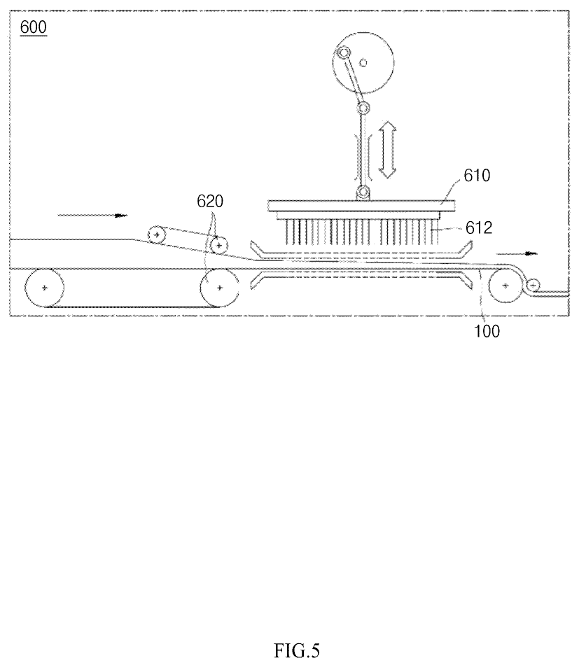

According to an embodiment of the present disclosure, the perforation PH may have a pin-hole shape penetrating the film layer 500. The perforations PH may be formed by the multiple perforating protrusions 702 formed on the outer circumference of the forming roller 700 in the manufacturing process of the automobile interior material 10 to be described later (see FIG. 5).

According to an embodiment of the present disclosure, the perforation PH may pass through the film layer 500 to the adhesive layer 400 therebelow. Accordingly, the perforation PH may expose one surface of the print layer 300 to the outside. In addition, the depth of the perforation PH may be appropriately adjusted depending on the thickness of each of the adhesive layer 400 and the film layer 500.

According to an embodiment of the present disclosure, the perforation PH may have a diameter of 850 μm or less, and as specific examples, may have a diameter of 845 μm or less, 840 μm or less, 835 μm or less, 830 μm or less, or 825 μm or less.

In addition, according to an embodiment of the present disclosure, the number of perforations PH may be 1,000 to 10,000 per 1 m² of the film layer 500, for a specific example, 1,100 to 9,000 per 1 m² thereof, and for a more specific example, 1,500 to 7,000 per 1 m² thereof.

When the perforation PH has a diameter in the above-mentioned range and is formed with a density in the above-mentioned range, gas that may be generated in the manufacturing process of the automobile interior material 10 to be described later may be more efficiently discharged and sound absorption may be further improved. Specifically, when the perforations PH are formed on the film layer 500, gas generated during the process of adhering the film layer 500 on the print layer 300 may be discharged. Additionally, when the automobile interior material 10 including the film layer 500 in which the perforations PH are formed is mounted on parts inside an automobile, the automobile interior material 10 may absorb noise originating from the interior of the automobile to create a comfortable indoor environment.

According to an embodiment of the present disclosure, the perforation PH may be formed on the protruding part. Specifically, the perforation PH may be formed on the protrusion surface of the protruding part PT. Accordingly, the perforation PH may not be seen by a user when the user looks at the automobile interior material 10, so the aesthetics of the automobile interior material 10 may not be damaged.

Hereinafter, the manufacturing method of the automobile interior material 10 according to an embodiment of the present disclosure will be described.

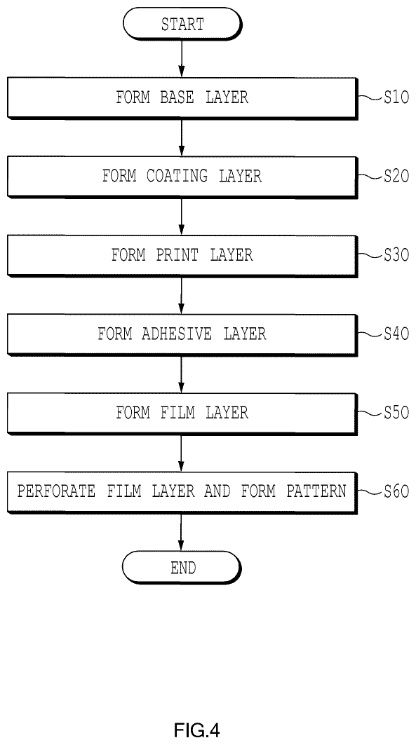

FIG. 4 is a flowchart showing the manufacturing method of the automobile interior material 10 according to an embodiment of the present disclosure, FIG. 5 is a state diagram showing a process of forming a base layer by using a needle punching machine in the manufacturing method of the automobile interior material 10 according to an embodiment of the present disclosure, and FIG. 6 is a state diagram showing the process of perforating a film layer and forming a pattern in the manufacturing method of the automobile interior material 10 according to an embodiment of the present disclosure.

Referring to FIG. 4, the manufacturing method of the automobile interior material 10 according to an embodiment of the present disclosure includes forming the base layer 100 through fiber coupling processing at S10, forming the coating layer 200 by coating one surface of the base layer 100 with one kind of emulsion or at least two kinds of emulsions at S20, forming the print layer 300 by printing a predetermined pattern on the top of the coating layer 200 at S30, applying the adhesive layer 400 on the top of the print layer 300 at S40, adhering the film layer 500 to the adhesive layer 400 at S50, and removing air bubbles by perforating the adhesive layer 400 and the film layer 500 at S60.

According to an embodiment of the present disclosure, in the forming of the base layer 100 at S10 as described above, the base layer 100 is formed of a non-woven fabric made by carding or cross-webbing thin fibers to form a web of 3 to 10 layers, and combining and processing the web of 3 to 10 layers.

According to an embodiment of the present disclosure, the base layer 100 manufactured by carding or cross-webbing may be transported to a needle punching machine 600 as shown in FIG. 5.

According to an embodiment of the present disclosure, the needle punching machine 600 may include an up-and-down moving plate 610, a punching needle 612, and a pressing roller 620.

According to an embodiment of the present disclosure, the base layer 100 may be pressed by the pressing roller 620, and the pressed base layer 100 may be punched by the punching needle 612 formed on the up-and-down moving plate 610, so that flexibility of the base layer 100 may be further improved.

According to an embodiment of the present disclosure, in the forming of the coating layer 200 at S20, the coating layer 200 is formed on one surface of the base layer 100 with one kind of emulsion or the mixture of at least two kinds of emulsions such as nylon, acryl, styrene, polyvinylchloride, polyvinyl alcohol, polyester, ethylenevinylchloride, ethylene vinyl acetate, polyurethane, etc. The coating layer 200 may include an additive such as a penetrant.

According to an embodiment of the present disclosure, in the forming of the print layer 300 at S30, the print layer 300 is formed by printing a predetermined pattern on one surface of the coating layer 200.

According to an embodiment of the present disclosure, in the applying of the adhesive layer 400 at S40, the adhesive layer 400 is applied to one surface of the print layer 300.

According to an embodiment of the present disclosure, in the adhering of the film layer 500 at S50, the film layer 500 is adhered to the adhesive layer 400. The film layer 500 is transparent and prevents contamination or deformation of the print layer 300. The film layer 500 may be implemented by coating the print layer 300, or by adhering a film for coating to the print layer 300 by using the adhesive layer 400. In this case, the adhesion of the film layer 500 may be performed under a high temperature condition, and in the adhesion process, air bubbles may be formed between the print layer 300 and the adhesive layer 400 due to the high temperature.

According to an embodiment of the present disclosure, in the removing of air bubbles at S60, which is a step of removing air bubbles by perforating the adhesive layer 400 and the film layer 500, as shown in FIG. 6, while the automobile interior material 10 is transported in one direction by a guide roller 710 and a take-out roller 720, the film layer 500 is perforated by being in contact with the forming roller 700.

According to an embodiment of the present disclosure, the multiple perforating protrusions 702 are formed on the outer circumference of the forming roller 700, and each of the perforating protrusions 702 has a diameter smaller than 850 μm. In addition, the perforating protrusions 702 of 1,000 to 10,000 per 1 m² are arranged at predetermined intervals. Furthermore, the patterning protrusions 704, together with the perforating protrusions 702, may be formed on the outer circumference of the forming roller 700. The patterning protrusions 704 form a predetermined pattern of depressed and protruding parts on the surface of the film layer 500. These depressed and protruding parts allow a specific texture to be expressed on the surface of the automobile interior material 10.

According to an embodiment of the present disclosure, each of the perforating protrusions 702 may be arranged between the patterning protrusions 704, and accordingly, the perforations PH formed on the surface of the film layer 500 may be respectively formed on the protrusion surfaces of the protruding parts PT formed on the surface of the film layer 500.

According to an embodiment of the present disclosure, the automobile interior material 10 before contact thereof with the forming roller 700 may be heated to a temperature higher than a room temperature in contact with the guide roller 710, which is arranged prior to the forming roller 700, perforated at a temperature higher than the room temperature, and may be cooled to the room temperature and hardened while the automobile interior material 10 is transported in one direction by the take-out roller 720 after the perforation. The surface temperature of the guide roller 710 is controlled by a temperature controller 712.

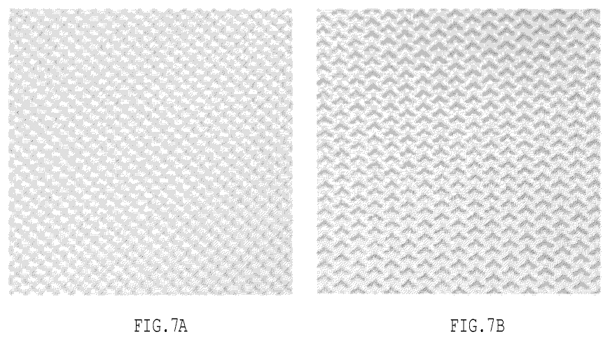

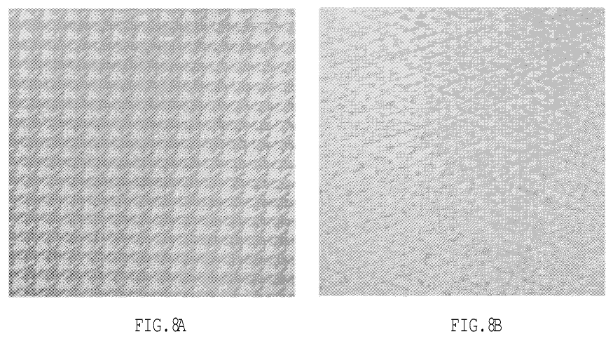

FIGS. 7A, 7B, 8A, and 8B are photos of surfaces of manufactured automobile interior materials 10.

As shown in FIGS. 7A, 7B, 8A, and 8B, the automobile interior material 10 according to an embodiment of the present disclosure may have patterns that are able to express various textures on the surface thereof, that is, the surface of the film layer 500. The film layer 500 makes colors and patterns expressed on the print layer 300 clear, protects the patterns from damage, and expresses a unique texture on the surface thereof. Accordingly, the automobile interior material 10 according to an embodiment of the present disclosure may provide three-dimensional information to a user by simultaneously expressing aesthetics and a tactile effect.

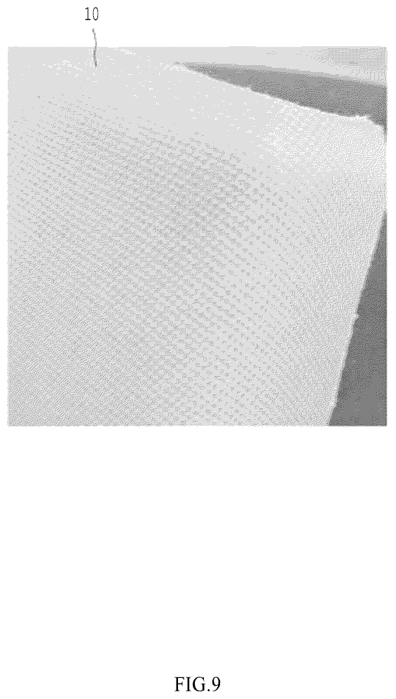

FIG. 9 is an image showing a curved state of the automobile interior material 10 according to an embodiment of the present disclosure.

As shown in FIG. 9, in the automobile interior material 10 according to an embodiment of the present disclosure, it may be seen that clear patterns are maintained even in curved parts, and the quality of the surface of the film layer 500 is maintained excellently.

In the above, the embodiments of the present disclosure have been described along with the drawings, but are illustrative and the present disclosure is not limited to the above-described embodiments and drawings. It is obvious that those skilled in the art may modify the present disclosure within the scope of the technical idea of the disclosed contents. In addition, even when an action or an effect according to a configuration is not explicitly described while explaining an embodiment of the present disclosure, it is natural that even predictable effects due to the configuration should be recognized.

According to the present disclosure, it is possible to provide the automobile interior material that is able to express aesthetics and tactile effects in three dimensions by enabling the expression of various colors and surface textures.

According to the present disclosure, it is possible to prevent the surface of the curved part of the interior material from being roughly deformed.

According to the present disclosure, a pattern printed on the surface of the interior material is maintained clear and protected from external contamination.

The effects of the present disclosure are not limited to those mentioned above, and other effects not mentioned will be clearly understood by those skilled in the art from the description below.

Hereinabove, although the present disclosure has been described with reference to the exemplary embodiment and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An automobile interior material comprising:
a base layer comprising a non-woven fabric;
a coating layer disposed on the base layer and comprising acrylic resin;
a print layer disposed on the coating layer and comprising a predetermined pattern printed thereon;
a film layer disposed on the print layer, and
an adhesive layer provided between the print layer and the film layer,
wherein each of the film layer and the adhesive layer has transparency.

2. The automobile interior material of claim 1, further comprising:
a perforation penetrating the film layer and the adhesive layer,
wherein the perforation comprises about 1,000 perforations or more and about 10,000 perforations or less per 1 m² on a basis of the film layer.

3. The automobile interior material of claim 2, wherein the perforation has a diameter of about 850 μm or less.

4. The automobile interior material of claim 1, wherein the film layer comprises a plurality of protruding parts protruding from a surface of the film layer, and a depressed part arranged between the plurality of protruding parts.

5. The automobile interior material of claim 4, further comprising:
a perforation penetrating the film layer and the adhesive layer,
wherein the perforation is formed on each of the plurality of protruding parts.

6. The automobile interior material of claim 1, wherein each of the adhesive layer and the film layer has a haze value of about 70% or more and about 80% or less measured by a haze meter.

7. A manufacturing method of an automobile interior material, the method comprising:
forming a base layer through fiber coupling processing;
forming a coating layer by coating one surface of the base layer with an emulsion;
forming a print layer by printing a predetermined pattern on a top of the coating layer;
applying an adhesive layer on a top of the print layer;
adhering a film layer on a top of the adhesive layer; and
removing air bubbles by perforating the film layer and the adhesive layer.

8. The method of claim 7, wherein in the removing, a pattern of depressed and protruding parts is formed on a surface of the film layer while perforating the film layer and the adhesive layer.

9. The method of claim 8, wherein in the removing, the surface of the film layer is in contact with a forming roller comprising perforating protrusions and patterning protrusions formed on an outer circumference thereof, so that the film layer and the adhesive layer are perforated, and the pattern of depressed and protruding parts is formed on the surface of the film layer.

10. The method of claim 9, wherein in the removing, a guide roller arranged prior to the forming roller is heated to a predetermined temperature by a temperature controller and heats the film layer and the adhesive layer while transporting the film layer and the adhesive layer.

11. An automobile interior material comprising:
a base layer comprising a non-woven fabric;
a coating layer disposed on the base layer and comprising;
a print layer disposed on the coating layer and comprising a predetermined pattern printed thereon;
a film layer disposed on the print layer, wherein the film layer comprises thermoplastic polyurethane resin (TPU); and
an adhesive layer provided between the print layer and the film layer,
wherein each of the film layer and the adhesive layer has transparency, having a total light transmittance Tt of about 90% or more and a haze value of about 70% or more and about 80% or less.

12. The automobile interior material of claim 11, wherein the emulsion is selected from the group consisting of nylon, acryl, styrene, polyvinylchloride, polyvinyl alcohol, polyester, ethylenevinylchloride, ethylene vinyl acetate, and polyurethane.

13. The automobile interior material of claim 11, further comprising:
a perforation penetrating the film layer and the adhesive layer,
wherein the perforation comprises about 1,000 perforations or more and about 10,000 perforations or less per 1 m² on a basis of the film layer.

14. The automobile interior material of claim 11, wherein the film layer comprises a plurality of protruding parts protruding from a surface of the film layer, and a depressed part arranged between the plurality of protruding parts.

15. The automobile interior material of claim 14, further comprising:
a perforation penetrating the film layer and the adhesive layer,
wherein the perforation is formed on each of the plurality of protruding parts.

16. The automobile interior material of claim 11, wherein each of the adhesive layer and the film layer has a haze value of about 70% or more and about 80% or less measured by a haze meter.

17. The automobile interior material of claim 11, wherein the print layer is printed by rotary screen printing.

18. The automobile interior material of claim 11, wherein the coating layer further comprises an additive selected from the group consisting of a penetrant, a thickener, and an antifoaming agent.

19. The automobile interior material of claim 11, wherein the non-woven fabric of the base layer is formed by carding or cross-webbing thin fibers to form a web of about 3 to about 10 layers, and coupling the layers to each other by needle punching or pressing.

20. A vehicle comprising the automobile interior material of claim 1.
